(19) United States
(12) Patent Application Publication
(10) Pub. No.: US 2026/0040243 A1
(43) Pub. Date: Feb. 5, 2026

(54) METHOD OF MULTI-MODAL SYNCHRONIZATION AND USER EQUIPMENT USING THE SAME

(71) Applicant: Industrial Technology Research Institute, Hsinchu (TW)

(72) Inventors: Tzu-Jane Tsai, Hsinchu County (TW); Chun-Yuan Chiu, Pingtung County (TW); Fang-Ching Ren, Hsinchu City (TW)

(73) Assignee: Industrial Technology Research Institute, Hsinchu (TW)

(21) Appl. No.: 19/280,125

(22) Filed: Jul. 25, 2025

Related U.S. Application Data
(60) Provisional application No. 63/678,065, filed on Aug. 1, 2024.
(60) Provisional application No. 63/730,966, filed on Dec. 12, 2024.

(51) Int. Cl. H04W 56/00

(52) U.S. Cl. CPC H04W 56/001

(57) ABSTRACT

A method of multi-modal synchronization and a user equipment are provided. The method includes: obtaining a first data flow to be transmitted via a first logical channel and a second data flow to be transmitted via a second logical channel; receiving an uplink grant and performing logical channel prioritization to select the first data flow; determining whether a first multi-modal service identifier of the first logical channel and a second multi-modal service identifier of the second logical channel are the same; and in response to the second multi-modal service identifier being the same as the first multi-modal service identifier, performing multiplexing for the first data flow and the second data flow.

### CROSS-REFERENCE TO RELATED APPLICATION

This application claims the priority benefit of U.S. provisional application Ser. No. 63/678,065, filed on Aug. 1, 2024 and U.S. provisional application Ser. No. 63/730,966, filed on Dec. 12, 2024. The entirety of each of the above-mentioned patent applications is hereby incorporated by reference herein and made a part of this specification.

### BACKGROUND

### Technical Field

The disclosure is directed to a method of multi-modal (MM) synchronization and a user equipment (UE).

### Description of Related Art

Multi-modal data of multi-modal communication services is defined to describe the input data from different kinds of devices/sensors or the output data to different kinds of destinations (e.g., one or more UEs) required for the same task or application. Multi-modal data consists of more than one single-modal data, and there is strong dependency among each single-modal data, wherein a single-modal data can be seen as one type of data (e.g., data corresponding to the same traffic type). For immersive multi-modal virtual reality (VR) applications, synchronization between different media components is critical to ensuring a seamless user experience. A lack of synchronization can negatively impact user perception, particularly when the synchronization threshold between multiple modalities is lower than the latency key performance indicator (KPI) of the applications. Therefore, achieving precise synchronization of multi-modal data corresponding to the same service is a crucial challenge.

### SUMMARY

The disclosure provides a method of multi-modal synchronization and a UE using the same method. The disclosure may ensure the synchronization for the multi-modal communication services.

The present disclosure is directed to a method of multi-modal synchronization, suitable for a user equipment, comprising: obtaining a first data flow to be transmitted via a first logical channel and a second data flow to be transmitted via a second logical channel; receiving an uplink grant and performing logical channel prioritization to select the first data flow; determining whether a first multi-modal service identifier of the first logical channel and a second multi-modal service identifier of the second logical channel are the same; and in response to the second multi-modal service identifier being the same as the first multi-modal service identifier, performing multiplexing for the first data flow and the second data flow.

The present disclosure is directed to a user equipment, comprising a transceiver and a processor. The processor is coupled to the transceiver and configured to: obtain a first data flow to be transmitted via a first logical channel and a second data flow to be transmitted via a second logical channel; receive an uplink grant and performing logical channel prioritization to select the first data flow; determine whether a first multi-modal service identifier of the first logical channel and a second multi-modal service identifier of the second logical channel are the same; and in response to the second multi-modal service identifier being the same as the first multi-modal service identifier, perform multiplexing for the first data flow and the second data flow.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 illustrates a schematic diagram of multi-modal data according to one embodiment of the present disclosure.

FIG. 2 illustrates a schematic diagram of mapping alternatives of QoS flow according to one embodiment of the present disclosure.

FIG. 3 illustrates a signaling diagram of synchronization enhancement of LCP according to one embodiment of the present disclosure.

FIG. 4 illustrates a schematic diagram of enhancement of LCP restriction based on the MMSID according to one embodiment of the present disclosure.

FIG. 5 illustrates a schematic diagram of enhancement of LCP restriction based on the MMSID with sub-logical channel according to one embodiment of the present disclosure.

FIG. 6 illustrates a schematic diagram of LCP resource allocation based on the MMSID according to one embodiment of the present disclosure.

FIG. 7 illustrates a schematic diagram of LCP resource allocation based on the MMSID with sub-logical channel according to one embodiment of the present disclosure.

FIG. 8 illustrates a schematic diagram of LCP resource allocation based on the data type of the LCHs according to one embodiment of the present disclosure.

FIG. 9 illustrates a schematic diagram of LCH buffer splitting based on MMSID according to one embodiment of the present disclosure.

FIG. 10 illustrates a schematic diagram of RLC bearer splitting based on QoS requirements according to one embodiment of the present disclosure.

FIG. 11 illustrates a flowchart of a method of multi-modal synchronization according to one embodiment of the present disclosure,

FIG. 12 illustrates a schematic diagram of a communication device according to one embodiment of the present disclosure.

### DESCRIPTION OF THE EMBODIMENTS

Multi-modal data consists of more than one type of data, where there is strong dependency among different types of data. To maintain the dependency of the multi-modal data, the multi-modal data may be proceeded using a single quality of service (QoS) flow or multiple QoS flows. A single QoS flow can maintain the dependency of the multi-modal data easily, but may lose QoS control granularity. Multiple QoS flows can provide a better QoS control granularity, but additional efforts are required to maintain the dependency for inter flow data.

Immersive multi-modal VR application describes the case of a human interacting with virtual entities in a remote environment such that the perception of interaction with a real physical world is achieved. As the asynchrony between different modalities increases, user's sense of presence and realism will decrease. Multi-modal synchronization threshold can be defined as the maximum tolerable temporal separation of two stimuli in the same data burst (or ONSET, packet data unit (PDU) set), wherein one of the stimuli is presented to one sense and the other to another sense, such that the accompanying sensory objects are perceived as being synchronous. Different type SDUs belong to the same data burst (or ONSET, PDU set) are expected to be received without exceed the synchronization threshold.

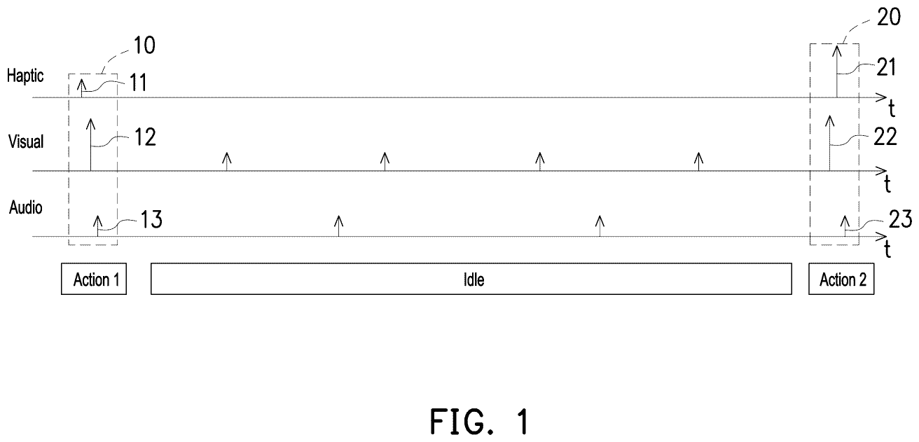

FIG. 1 illustrates a schematic diagram of multi-modal data according to one embodiment of the present disclosure. Assume that the data burst 10 includes the service data unit (SDU) 11 corresponding to the haptic traffic flow, the SDU 12 corresponding to the visual traffic flow, and the SDU 13 corresponding to the audio traffic flow, and the data burst 20 includes the SDU 21 corresponding to the haptic traffic flow, the SDU 22 corresponding to the visual traffic flow, and the SDU 23 corresponding to the audio traffic flow. The latencies between the SDU 11, SDU 12, and SDU 13 are expected to be lower than synchronization threshold since these SDUs belong to the same data burst.

For multi-modal extended reality (XR) applications, radio access network (RAN) becomes a bottleneck in the multi-modal synchronization. Haptic data requires very stringent delay budget and the burst size or periodicity of data bursts of a multi-modal service can be unpredictable and irregular. For example, the data burst 10 can be generated after Action 1 is performed by a user. It is hard to predict when will the user perform Action 2 or when will the data burst 20 be generated. When the user stays idle, some data (e.g., visual traffic or audio traffic as shown in FIG. 1) uncorrelated with any actions may be detected. Because the RAN currently does not have multi-modal awareness, the logical channel prioritization (LCP) allocates resources in a decreasing logical channel (LCH) priority order and cannot support the multi-modal synchronization. That is, the LCP cannot make an appropriate medium access control (MAC) PDU for multi-modal synchronization. Therefore, RAN needs to be enhanced to support synchronization for multi-modal services.

From the point of view of the RAN, data that are related in time will only be in one data burst. A synchronized burst is composed with more than one SDUs from dependent QoS flows. It is reasonable to assume that the interval between a synchronized burst and the subsequent synchronized burst will be much larger than the synchronization threshold of the dependent data. That is, for two adjacent synchronized bursts, the probability that their respective SDUs (or PDUs) exist in a UE's packet data convergence protocol (PDCP) buffer at the same time is very low. Take FIG. 1 as an example, the interval between the data burst 10 and the data burst 20 can be much larger than the synchronization threshold. The probability that SDU 11 (or SDU 12, SDU 13) and SDU 21 (or SDU 22, SDU 23) in the UE's buffer in the same time is very low.

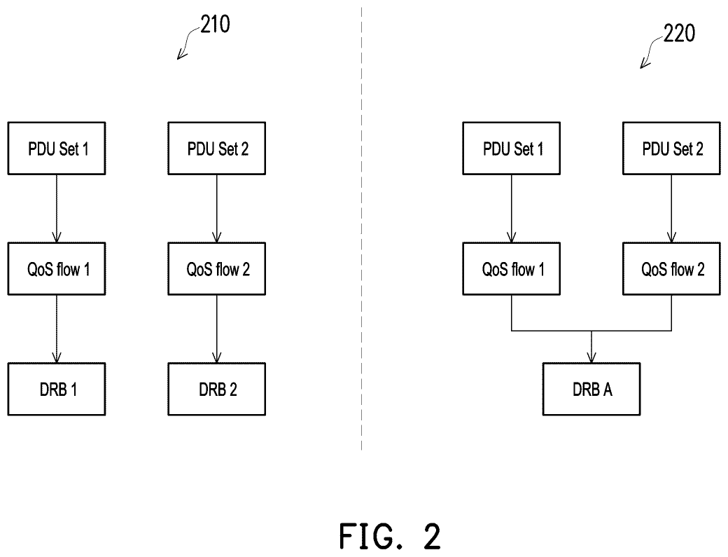

FIG. 2 illustrates a schematic diagram of mapping alternatives of QoS flow according to one embodiment of the present disclosure. In mapping alternative 210, the ratio of the number of QoS flows and the number of data radio bearers (DRBs) can be 1:1, wherein each DRB may be mapped to a corresponding PDCP entity. For example, the QoS flow 1 corresponding to the PDU set 1 and the QoS flow 2 corresponding to the PDU set 2 can be transmitted via different DRBs (e.g., DRB 1 and DRB 2) respectively. In mapping alternative 220, the ratio of the number of QoS flows and the number of DRBs can be N:1, where N is a positive integer greater than 1. For example, the QoS flow 1 corresponding to the PDU set 1 and the QoS flow 2 corresponding to the PDU set 2 can be transmitted via the same DRB (e.g., DRB A).

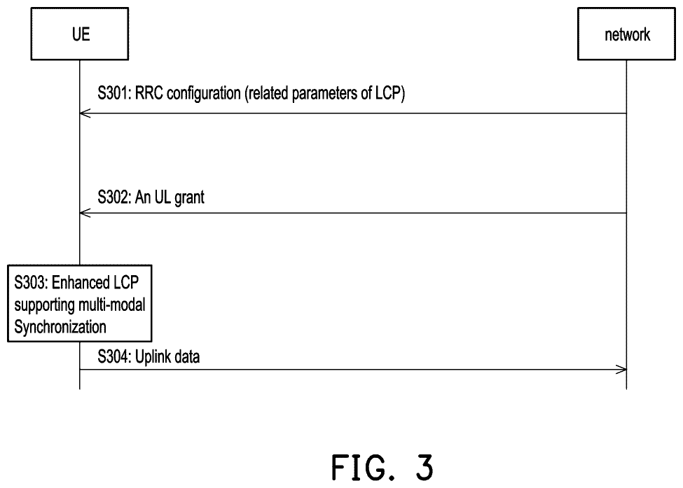

FIG. 3 illustrates a signaling diagram of synchronization enhancement of LCP according to one embodiment of the present disclosure. In step S301, the network (e.g., next generation radio access network (NG-RAN), gNB, or base station) may transmit a radio resource control (RRC) configuration message to the UE, wherein the RRC configuration message may include related parameters of LCP.

In step S302, the network may transmit an uplink (UL) grant to the UE. The UL grant may indicate UL resources for the UE to transmit data to the network.

In step S303, in response to receiving the UL grant, the UE may perform enhanced LCP which supporting multi-modal synchronization.

In step S304, the UE may transmit UL data to the NG-RAN based on the UL grant, wherein the UL data to be transmitted may be determined based on the result of the enhanced LCP.

In a scenario where a UE obtains a multi-modal burst and a network (e.g., gNB) transmits a dedicated UL grant to the UE for the multi-modal burst, an enhanced LCP restriction mapping can be executed to prevent a non-mapping LCH from competing for the dedicated UL resource.

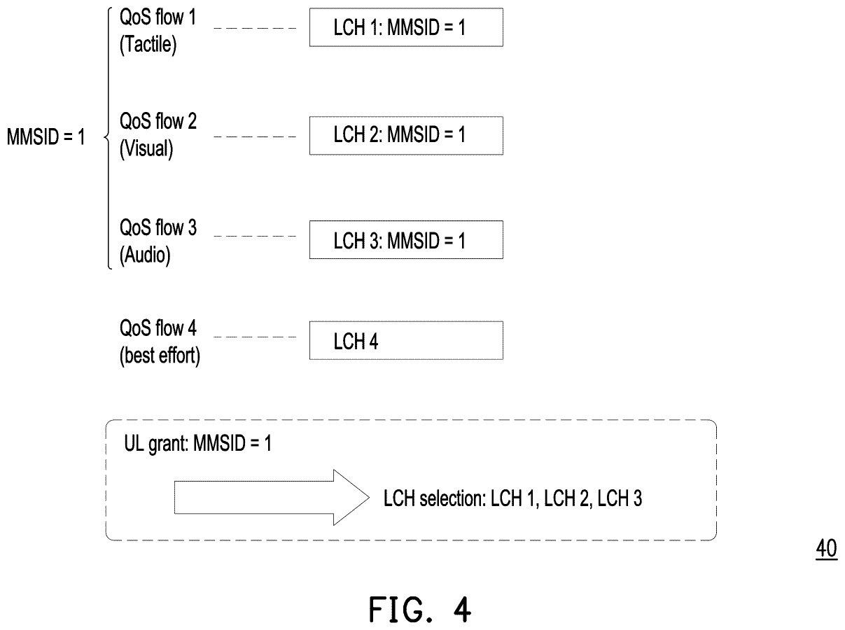

FIG. 4 illustrates a schematic diagram 40 of enhancement of LCP restriction based on the MMSID according to one embodiment of the present disclosure, wherein the LCP restriction can be implemented by an entity of UE (e.g., MAC entity of UE). In a scenario where the ratio of the number of QoS flows and the number of DRBs is 1:1, the network (e.g., gNB) may provide an LCH configuration or a logical channel group (LCG) configuration (e.g., LCG including LCH 1, LCH 2, and LCH 3 as shown in FIG. 4) to the UE. The network may know that the UE has a multi-modal burst to be transmitted in a buffer based on a status report (e.g., buffer status report or delay status report) and the LCH/LCG configuration, and the network may respond a dedicated UL grant with a multi-modal service identifier (MMSID) to the UE. A MMSID may indicate certain service flows belong to the same multi-modal service/session. The MMSID may be applied in an application function (AF) or a policy control function (PCF) and may be provided to NG-RAN.

An entity (e.g., MAC entity) of the UE may obtain a plurality of QoS flows from the upper layer (e.g., radio link control (RLC) layer) of the UE. For example, the MAC entity may obtain QoS flow 1 corresponding to tactile data, QoS flow 2 corresponding to visual data, and QoS flow 3 corresponding to audio data, wherein the UE may obtain QoS flow 1, QoS flow 2, and QoS flow 3 via LCH 1, LCH 2, and LCH 3 respectively. The QoS flows to be transmitted can be stored in a buffer (e.g., MAC buffer) of the UE. After receiving a UL grant from the network, the UE may perform LCP based on the UL grant and select a QoS flow to be transmitted first (i.e., the QoS flow with the highest priority) based on the result of the LCP.

UE determines whether a multi-modal service identifier associated with the uplink grant matches the allowed list of the multi-modal service identifier of the selected logical channel; and in response to the multi-modal service identifier associated with the uplink grant matching the allowed list of the selected logical channel (e.g., LCH 1, LCH 2, LCH 3), performing the multiplexing for the matched data flow via their corresponding logical channel. If the MMSID of the specific QoS flow and the MMSID associated with the uplink grant are different, the UE may deliver the specific QoS flow to the network from the buffer after the selected QoS flow is delivered to the network. That is, the priority value of the selected QoS flow is smaller than the priority value of the specific QoS flow, wherein a smaller priority value indicates a higher priority and a larger priority value indicates a lower priority.

For example, the UE may determine that the MMSID of QoS flow 1, QoS flow 2 or QoS flow 3 matches the MMSID associated with the uplink grant. Accordingly, QoS flows 1-3 may be transmitted to the network from the buffer of the UE via LCHs 1, 2, and 3 based on the same UL grant. The UE may determine that the MMSID of QoS flow 4 does not match the MMSID associated with the uplink grant since the two MMSIDs are different. Accordingly, QoS flow 4 may be transmitted to the network from the buffer of the UE after QoS flows 1-3 are transmitted.

In one embodiment, the UE may allow data that does not meet the LCP restriction to be transmitted using the UL grant if there are remaining resources. For example, if part of resources indicated by the UL grant is not consumed by QoS flows 1-3, the UE may transmit QoS flow 4 by using the remain resources.

In one embodiment, the RRC layer controls the synchronization or QoS of multi-modality by configuring mapping restrictions for a logical channel, wherein allowedMMSID-List may set the one or more allowed MMSIDs for transmission. The allowedMMSID-List is updated according to the cross-layer interaction between the application layer and the RRC layer. An UE may receive a configuration message and obtain the allowedMMSID-List from the configuration message. The MAC entity may determine whether a MMSID associated with the UL grant matches the allowedMMSID-List of the MMSID corresponding to the logical channel. If the MMSID matches the allowedMMSID-List (e.g., the MMSID is recorded on the allowedMMSID-List), the MAC entity may perform multiplexing or transmission for a QoS flow corresponding to the MMSID via an LCH.

In one embodiment, a MAC entity shall, when a new transmission is performed: select the logical channels for each UL grant that satisfy the following condition: the set of allowed MMSID values in the allowedMMSID-List, if configured, includes the MMSID associated with the UL grant.

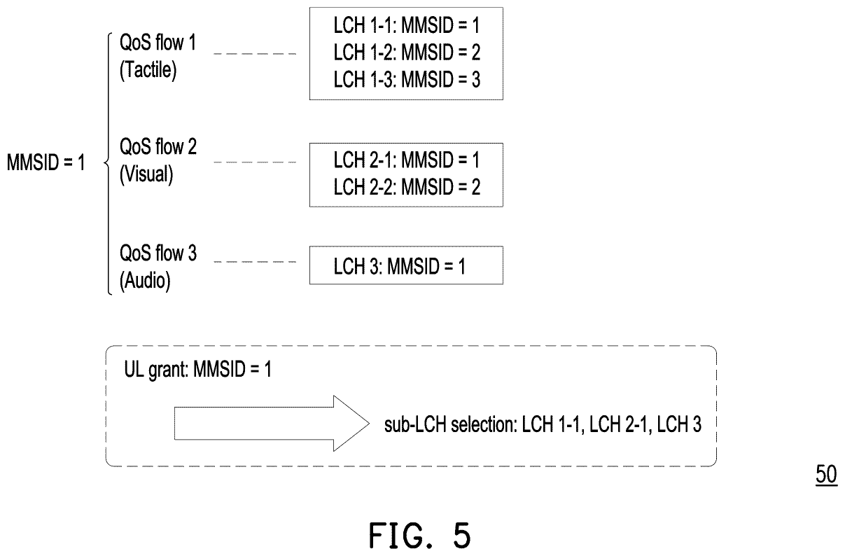

FIG. 5 illustrates a schematic diagram 50 of enhancement of LCP restriction based on the MMSID with sub-logical channel according to one embodiment of the present disclosure, wherein the LCP restriction can be implemented by an entity of UE (e.g., MAC entity of UE). In a scenario where the ratio of the number of QoS flows and the number of DRBs is N:1 (N may be a positive integer greater than 1), the network (e.g., gNB) may provide an LCH configuration or an LCG configuration (e.g., LCG including sub-LCHs 1-1, 2-1, or 3 as shown in FIG. 5) to the UE. The network may know that the UE has a multi-modal burst to be transmitted in a buffer based on a status report (e.g., buffer status report or delay status report) according to the LCH/LCG configuration, and the network may respond a dedicated UL grant with a MMSID to the UE.

An entity (e.g., MAC entity) of the UE may obtain a plurality of QoS flows from an upper layer (e.g., RLC layer) of the UE, wherein each QoS flow may include data of one or more services to be transmitted via one or more sub-LCHs respectively. For example, the MAC entity may obtain a plurality of QoS flows (or data flows) including QoS flow 1 correspond to tactile data, QoS flow 2 corresponding to visual data, and QoS flow 3 corresponding to audio data. QoS flow 1 may include a sub-QoS flow corresponding to MMSID=1 and sub-LCH 1-1, a sub-QoS flow corresponding to MMSID=2 and sub-LCH 1-2, and a sub-QoS flow corresponding to MMSID=3 and sub-LCH 1-3. QoS flow 2 may include a sub-QoS flow corresponding to MMSID=1 and sub-LCH 2-1 and a sub-QoS flow corresponding to MMSID=2 and sub-LCH 2-2. QoS flow 3 may include a sub-QoS flow corresponding to MMSID=1 and sub-LCH 3. The sub-QoS flows to be transmitted can be stored in a buffer (e.g., MAC buffer) of the UE. After receiving a UL grant from the network, the UE may perform LCP based on the UL grant and select a sub-QoS flow to be transmitted first based on the result of the LCP.

Assume that the UE selects a sub-QoS flow corresponding to the sub-LCH 1-1, sub-LCH 2-1, or sub-LCH 3, and the MMSID of the selected sub-QoS flows (i.e., sub-QoS flow corresponding to sub-LCH 1-1, sub-LCH 2-1 or sub-LCH 3) are the same with the MMSID associated with the uplink grant. The UE may deliver the selected sub-QoS flow to the network from the buffer based on the same UL grant or UL resources. The selected sub-QoS flow may belong to different QoS flows. For example, if the selected sub-QoS flow belongs to the tactile QoS flow 1, the other selected sub-QoS flow may belong to the visual QoS flow 2 or the audio QoS flow 3. On the other hand, if the MMSID of the specific sub-QoS flow and the MMSID associated with the uplink grant are different, the UE may deliver the specific sub-QoS flow to the network from the buffer after the selected sub-QoS flow is delivered to the network. That is, the priority value of the selected sub-QoS flow is smaller than the priority value of the specific sub-QoS flow, wherein a smaller priority value indicates a higher priority and a larger priority value indicates a lower priority.

For example, the UE may determine that the MMSID of sub-QoS flow corresponding to sub-LCH 1-1 and the MMSID of sub-QoS flow corresponding to sub-LCH 2-1 (or sub-LCH 3) matching the MMSID are associated with the uplink grant. Accordingly, sub-QoS flows corresponding to sub-LCH 1-1, sub-LCH 2-1, and sub-LCH 3 respectively may be transmitted to the network from the buffer of the UE based on the same UL grant. The UE may determine that the MMSID of sub-QoS flow corresponding to sub-LCH 1-2 (or sub-LCH 1-3 or sub-LCH 2-2) does not match the MMSID associated with the uplink grant. Accordingly, the sub-QoS flow corresponding to sub-LCH 1-2 (or sub-LCH 1-3 or sub-LCH 2-2) may be transmitted to the network from the buffer of the UE after the sub-QoS flows corresponding to sub-LCH 1-1, sub-LCH 2-1, and sub-LCH 3 are transmitted.

In one embodiment, the UE may allow data that does not meet the LCP restriction to be transmitted using the UL grant if there are remaining resources.

In one embodiment, the RRC layer controls the synchronization or QoS of multi-modality by configuring mapping restrictions for a logical channel, wherein allowedMMSID-List may set the one or more allowed MMSIDs for transmission. The allowedMMSID-List is updated according to the cross-layer interaction between the application layer and the RRC layer. Each MMSID is associated with corresponding sub-logical channel. A UL grant may include a MMSID, a MM-only indication, or MM-first indication. A UE may receive a configuration message and obtain the allowedMMSID-List from the configuration message. The MAC entity may determine whether a MMSID associated with the UL grant matches the allowedMMSID-List of the MMSID corresponding to the sub-logical channel. If the MMSID matches the allowedMMSID-List (e.g., the MMSID is recorded on the allowedMMSID-List), the MAC entity may perform multiplexing or transmission for a sub-QoS flow corresponding to the MMSID via a sub-LCH.

In one embodiment, a MAC entity shall, when a new transmission is performed: select the logical channels or sub-logical channels for each UL grant that satisfy the following condition: the set of allowed MMSID values in allowedMMSID-List, if configured for the sub-logical channel, includes the MMSID associated with the UL grant.

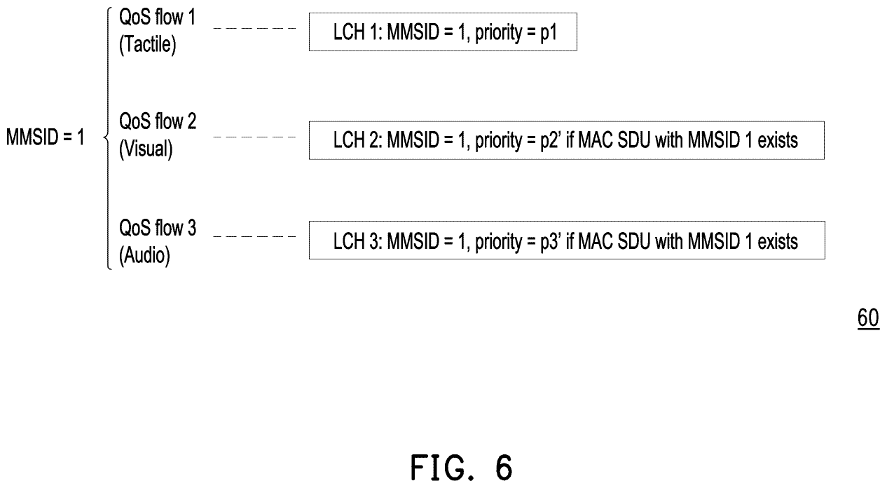

FIG. 6 illustrates a schematic diagram 60 of LCP resource allocation based on the MMSID according to one embodiment of the present disclosure, wherein the LCP resource allocation can be implemented by an entity of UE (e.g., MAC entity of UE). In a scenario where the ratio of the number of QoS flows and the number of DRBs is 1:1, the network (e.g., gNB) may provide an LCH configuration or an LCG configuration (e.g., LCG including LCH 1, LCH 2, and LCH 3 as shown in FIG. 6) to the UE. The network may know that the UE has a multi-modal burst to be transmitted in a buffer based on a status report (e.g., buffer status report or delay status report) according to the LCH/LCG configuration, and the network may respond a dedicated UL grant with a MMSID to the UE.

An entity (e.g., MAC entity) of the UE may obtain a plurality of QoS flows from the upper layer (e.g., RLC layer) of the UE. For example, the MAC entity may obtain QoS flow 1 corresponding to tactile data, QoS flow 2 corresponding to visual data, and QoS flow 3 corresponding to audio data, wherein the UE may obtain QoS flow 1, QoS flow 2, and QoS flow 3 via LCH 1, LCH 2, and LCH 3 respectively. The QoS flows to be transmitted can be stored in a buffer (e.g., MAC buffer) of the UE. After receiving a UL grant from the network, the UE may perform LCP based on the UL grant and select a QoS flow to be transmitted first (i.e., the QoS flow with the highest priority) based on the result of the LCP.

Assume that the UE select QoS flow 1 as the QoS flow to be transmitted first. The UE may determine whether a MMSID of a specific QoS flow (e.g., QoS flows 2 or 3) and the MMSID of the selected QoS flow (i.e., QoS flow 1) are the same. If the MMSID of the specific QoS flow and the MMSID of the selected QoS flow are the same, the UE may increase the priority of the LCH corresponding to the specific QoS flow or the UE may apply an additional priority of the specific QoS flow (e.g., the priority applied to the LCH corresponding to the specific QoS flow). The additional priority may be configured from the configuration message. The UE may perform multiplexing for the specific QoS flow according to the priority of the corresponding LCH. That is, the UE may deliver the specific QoS flow to the network from the buffer based on the increased priority of the specific QoS flow. The priority of the LCH corresponding to the specific QoS flow may be restored to the original value after the specific QoS flow data are transmitted. The priority of the specific QoS flow may be increased during a time period (or a synchronization threshold) after QoS flow 1 has been selected by the UE. The priority of the LCH corresponding to the specific QoS flow may be restored to the original value after the time period. On the other hand, if the MMSID of the specific QoS flow and the MMSID of the selected QoS flow are different, the UE may not increase the priority of the LCH corresponding the specific QoS flow. The UE may deliver the specific QoS flow to the network from the buffer based on the original priority of the specific QoS flow. The priority (or priority value) of a QoS flow may be configured to the UE via an RRC message. The features mentioned above may also be applied when there are sub-LCHs in the LCH or when there are sub-QoS flows in the QoS flow.

In one embodiment, if data of the selected QoS flow and data of the specific QoS flow are in the buffer of the UE, the UE may deliver the selected QoS flow and the specific QoS flow based on the same UL grant in response to the MMSID of the specific QoS flow being the same as the MMSID of the selected QoS flow.

Assume that the priority values of LCH 1, LCH 2, and LCH 3 are configured to p1, p2, and p3 respectively, wherein p1<p2<p3, wherein a smaller priority value indicates a higher priority and a larger priority value indicates a lower priority. The priority of LCH 1 is higher than the priority of LCH 2 or LCH 3. It is possible that only LCH 2 and LCH 3 have data in the buffer of the UE. When LCH 1 has MMSID data in the buffer of the UE, LCH 2 and LCH 3 should transmit data with the same MMSID belonging to the burst as soon as possible under the synchronization requirements. In one example, assume that LCH 1 has data with MMSID 1 in the buffer. If a MAC service data unit (SDU) with MMSID 1 exists in LCH 2 or LCH 3, the UE may handle LCH 2 or LCH 3 immediately after LCH 1 is handled. Specifically, the UE may update the priority value p2 of LCH 2 to p2′ or update the priority value p3 of LCH 3 to p3′, wherein p2′=p3′=p1. In another example, assume LCH 1 has data with MMSID 1 in the buffer. If a MAC SDU with MMSID 1 exists in LCH 2 or LCH 3, the UE may update the priority value p2 to p2′ or update the priority value p3 to p3′, wherein p2′<p2 and p3′<p3. That is, LCH 2 or LCH 3 may have higher priority or higher transmission probability if MAC SDU with MMSID 1 exists.

In one embodiment, the RRC layer controls the synchronization/QoS of multi-modality by configuring a specific priority for an LCH. Each MMSID is associated with one or more corresponding LCHs. An entity (e.g., MAC entity) of the UE shall, when a new transmission is performed: allocate resources to the logical channels as follows: if a logical channel has data with a MMSID in the buffer, the MAC entity shall update the priority of other logical channel having data with the same MMSID in the buffer to a configured specific priority, wherein the specific priority may be a fixed value (e.g., the value same as the priority value of the logical channel), or the specific priorities of different LCHs may be configured individually by the gNB.

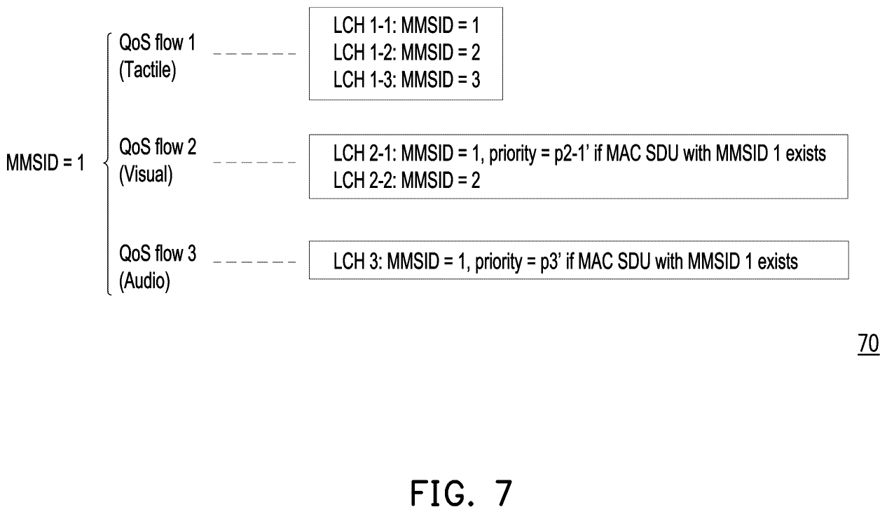

FIG. 7 illustrates a schematic diagram 70 of LCP resource allocation based on the MMSID with sub-logical channel according to one embodiment of the present disclosure, wherein the LCP resource allocation can be implemented by an entity of UE (e.g., MAC entity of UE). In a scenario where the ratio of the number of QoS flows and the number of DRBs is N:1, the network (e.g., gNB) may provide an LCH configuration or an LCG configuration (e.g., LCG including sub-LCHs 1-1, 2-1, or 3 as shown in FIG. 7) to the UE. The network may know that the UE has a multi-modal burst to be transmitted in a buffer based on a status report (e.g., buffer status report or delay status report) according to the LCH/LCG configuration, and the network may respond a dedicated UL grant with a MMSID to the UE.

An entity (e.g., MAC entity) of the UE may obtain a plurality of QoS flows from the upper layer (e.g., RLC layer) of the UE, wherein each QoS flow may include data of one or more services to be transmitted via one or more sub-LCHs respectively. For example, the MAC entity may obtain a plurality of QoS flows (or data flows) including QoS flow 1 corresponding to tactile data, QoS flow 2 corresponding to visual data, and QoS flow 3 corresponding to audio data. QoS flow 1 may include a sub-QoS flow corresponding to MMSID=1 and sub-LCH 1-1, a sub-QoS flow corresponding to MMSID=2 and sub-LCH 1-2, and a sub-QoS flow corresponding to MMSID=3 and sub-LCH 1-3. QoS flow 2 may include a sub-QoS flow corresponding to MMSID=1 and sub-LCH 2-1 and a sub-QoS flow corresponding to MMSID=2 and sub-LCH 2-2. QoS flow 3 may include a sub-QoS flow corresponding to MMSID=1 and sub-LCH 3. The sub-QoS flows to be transmitted can be stored in a buffer (e.g., MAC buffer) of the UE. After receiving a UL grant from the network, the UE may perform LCP based on the UL grant and select a sub-QoS flow to be transmitted first based on the result of the LCP.

Assume that the UE select a sub-QoS flow corresponding to the sub-LCH 1-1 as the QoS flow to be transmitted first. The UE may determine whether a MMSID of a specific sub-QoS flow (e.g., sub-QoS flows corresponding to sub-LCH 2-1 or sub-LCH 3) and the MMSID of the selected sub-QoS flow (i.e., sub-QoS flow corresponding to sub-LCH 1-1) are the same. If the MMSID of the specific sub-QoS flow and the MMSID of the selected sub-QoS flow are the same, the UE may increase the priority of the specific sub-QoS flow. The UE may perform multiplexing for the specific sub-QoS flow. That is, the UE may deliver the specific sub-QoS flow to the network from the buffer based on the increased priority of the specific sub-QoS flow. The priority of the specific sub-QoS flow may be increased during a time period (or a synchronization threshold) after sub-QoS flow corresponding to the sub-LCH 1-1 has been selected by the UE. On the other hand, if the MMSID of the specific sub-QoS flow and the MMSID of the selected sub-QoS flow are different, the UE may not increase the priority of the specific sub-QoS flow. The UE may deliver the specific sub-QoS flow to the network from the buffer based on the original priority of the specific sub-QoS flow. The priority (or priority value) of a sub-QoS flow may be configured to the UE via an RRC message.

In one embodiment, if data of the selected sub-QoS flow and data of the specific sub-QoS flow are in the buffer of the UE, the UE may deliver the selected sub-QoS flow and the specific sub-QoS flow based on the same UL grant in response to the MMSID of the specific sub-QoS flow being the same as the MMSID of the selected sub-QoS flow.

Assume that the priority values of sub-LCH 1-1, sub-LCH 2-1, and sub-LCH 3 are configured to p1-1, p2-1, and p3 respectively. In one example, assumed that sub-LCH 1 has data with MMSID 1 in the buffer. If a MAC SDU with MMSID 1 exists in sub-LCH 2-1 or sub-LCH 3, the UE may handle sub-LCH 2-1 or sub-LCH 3 immediately after sub-LCH 1-1 is handled. Specifically, the UE may update the priority value p2-1 of sub-LCH 2-1 to p2-1′ or update the priority value p3 of sub-LCH 3 to p3′, wherein p2-1′=p3′=p1-1. In another example, assume that sub-LCH 1-1 has data with MMSID 1 in the buffer. If a MAC SDU with MMSID 1 exists in sub-LCH 2-1 or sub-LCH 3, the UE may update the priority value p2-1 to p2-1′ or update the priority value p3 to p3′, wherein p2-1′<p2-1 and p3′<p3. That is, sub-LCH 2 or sub-LCH 3 may have higher priority or higher transmission probability if MAC SDU with MMSID 1 exists.

In one embodiment, the RRC layer controls the synchronization/QoS of multi-modality by configuring a specific priority for a sub-LCH. Each MMSID is associated with one or more corresponding sub-LCHs. An entity (e.g., MAC entity) of the UE shall, when a new transmission is performed: allocate resources to the sub-logical channels as follows: if a sub-logical channel has data with a MMSID in the buffer, the MAC entity shall update the priority of other sub-logical channel having data with the same MMSID in the buffer to a configured specific priority, wherein the specific priority may be a fixed value (e.g., the value same as the priority value of the sub-logical channel), or the specific priorities of different sub-LCHs may be configured individually by the gNB.

A budget variable Bj corresponding to LCH j (or sub-LCH j) may be configured to the UE. The value of Bj can be positive or negative. The value of Bj may increase over while time. The UE may deliver data via LCH j if Bj is greater than or equal to a threshold (e.g., Bj≥0). After the UE deliver the data from the buffer of the UE to the network via LCH j, the UE may decrease Bj.

In one embodiment, the relaxation of Bj can be performed by the UE. Assume that an LCH is selected by the UE based on the result of the LCP. The UE may determine whether the MMSID of LCH j (e.g., the LCH with lower priority) is the same as the MMSID of the selected LCH (e.g., the LCH with higher priority). If the MMSID of LCH j is different from the MMSID of the selected LCH, the transmission via LCH j may be restricted by Bj. For example, the UE may deliver data from the buffer to the network via LCH j if Bj is greater than or equal to a threshold. If Bj drops below the threshold, the UE may not deliver the data via LCH j. On the other hand, if the MMSID of LCH j is the same as the MMSID of the selected LCH, the transmission via LCH j may not be restricted by Bj. For example, the UE may deliver data from the buffer to the network via LCH j regardless of whether Bj is greater than, equal to, or below to the threshold. In one embodiment, although the UE may neglect the restriction of Bj when the MMSID of LCH j and the selected LCH are the same, the UE may still decrease the value of Bj after delivering the data to the network via LCH j.

In one embodiment, an entity (e.g., MAC entity) of UE shall, when a new transmission is performed: allocate resource to the logical channels as follows: if a logical channel has data with MMSDI in the buffer, and logical channel j has data with the same MMSID in the buffer, logical channel j is allocated with resources, and the UE may decrement Bj by the total size of MAC SDUs with the same MMSID served to logical channel j.

In one embodiment, an entity (e.g., MAC entity) of UE shall, when a new transmission is performed: allocate resource to the logical channels as follows: if a logical channel has data with MMSDI in the buffer, and logical channel j with higher priority (i.e., smaller priority value) has data with the same MMSID in the buffer, logical channel j is allocated with resources, and the UE may decrement Bj by the total size of MAC SDUs with the same MMSID served to logical channel j.

In one embodiment, an entity (e.g., MAC entity) of UE shall, when a new transmission is performed: allocate resource to the logical channels as follows: if a logical channel has data with MMSID in the buffer, and logical channel j with higher priority (i.e., smaller priority value) has data with the same MMSID in the buffer, the logical channel j is allocated with resources, and the UE may decrement Bj by the value: max {total size of MAC SDUs with the same MMSID served to logical channel j, a configured threshold of logical channel j}.

In one embodiment, the priorities of LCHs may be determined based on the data types of the LCHs. For example, the LCH priority may be configured such that tactile-LCH>visual-LCH>audio-LCH. Assume that the tactile-LCH is selected by the UE first based on the result of the LCP and the tactile-LCH has data with a MMSID in the buffer of the UE. If the data of the tactile-LCH belong to a synchronization burst, the visual-LCH or audio-LCH will transmit data belonging the same synchronization burst under the synchronization requirements. If the visual-LCH or audio-LCH has data with the same MMSID, the MAC entity of the UE may assign a specific priority to the visual-LCH or audio-LCH during a subsequent duration, wherein the time value of the subsequent duration may be equal to a synchronization threshold (e.g., SYNCThreshold). Accordingly, the UE may ensure that the burst of the same MMSID will be multiplexed as soon as possible. A new MM synchronization timer may be introduced to count down the time. Table 1 is an example of the synchronization threshold. The UE may transmit the data of the visual-LCH or audio-LCH within the synchronization threshold after the tactile-LCH is selected or the data of the tactile-LCH is transmitted.

TABLE 1

| Media component | synchronization threshold |
|---|---|
| tactile/audio | audio delay: 50 ms |
| tactile/visual | visual delay: 15 ms |

Assume that the visual-LCH or the audio-LCH is selected by the UE first based on the result of the LCP, and the visual-LCH or the audio-LCH obtains data with a MMSID belonging to a synchronization burst and the LCP is going to handle the data. If data belonging to the synchronization burst in the tactile-LCH cannot be handled due to the Bj<0 limitation, Bj<0 limitation may be relaxed. If the data of the tactile-LCH with the same MMSID exists but is not scheduled (e.g., due to Bj<0 limitation), the data of the tactile-LCH corresponding to the MMSID will be multiplexed as soon as possible with relaxation of Bj. Table 2 is an example of the synchronization threshold. The UE may transmit the data of the tactile-LCH within the synchronization threshold after the visual-LCH (or audio-LCH) is selected or the data of the visual-LCH (or audio-LCH) is transmitted.

TABLE 2

| Media component | synchronization threshold |
|---|---|
| audio/tactile | tactile delay: 25 ms |
| visual/tactile | tactile delay: 50 ms |

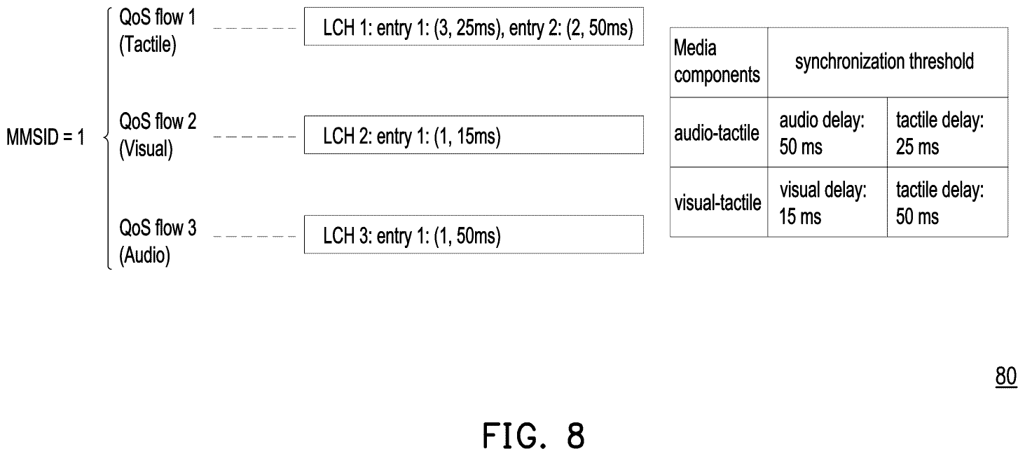

FIG. 8 illustrates a schematic diagram 80 of LCP resource allocation based on the data type of the LCHs according to one embodiment of the present disclosure, wherein the LCP resource allocation can be implemented by an entity of UE (e.g., MAC entity). An entity (e.g., MAC entity) of the UE may obtain a plurality of QoS flows from the upper layer (e.g., RLC layer) of the UE. For example, the MAC entity may obtain QoS flow 1 corresponding to tactile data, QoS flow 2 corresponding to visual data, and QoS flow 3 corresponding to audio data, wherein the UE may obtain QoS flow 1, QoS flow 2, and QoS flow 3 via LCH 1, LCH 2, and LCH 3 respectively. The QoS flows to be transmitted can be stored in a buffer (e.g., MAC buffer) of the UE. After receiving a UL grant from the network, the UE may perform LCP based on the UL grant and select a QoS flow to be transmitted first (i.e., the QoS flow with the highest priority) based on the result of the LCP.

The priority of the specific QoS flow may be increased during a time period (or a synchronization threshold) after QoS flow 1 has been selected by the UE. If data of the selected QoS flow and data of the specific QoS flow are in the buffer of the UE, the UE may deliver the selected QoS flow and the specific QoS flow based on the same UL grant in response to the MMSID of the specific QoS flow being the same as the MMSID of the selected QoS flow. The UE may increase the priority of the specific QoS flow in response to the MMSID of the specific QoS flow being the same as the MMSID of the selected QoS flow.

Assume that the UE select QoS flow 1 as the QoS flow to be transmitted first and the priority values of LCH 1, LCH 2, and LCH 3 are configured to p1, p2, and p3 respectively, wherein p1<p2<p3. If LCH 1 has data with MMSID 1 in the buffer and LCH 2 or LCH 3 has data with the same MMSID (i.e., MMSID 1) in the buffer of the UE, the UE may update the priority value p2 of LCH 2 to p2′ during 15 ms (e.g., synchronization threshold for tactile/visual) after QoS flow 1 has been selected by the UE, or the UE may update the priority value p3 of LCH 3 to p3′ during 50 ms (e.g., synchronization threshold for tactile/audio) after QoS flow 1 has been selected by the UE, wherein p2′<p2 or p3′<p3. On the other hand, if the UE select QoS flow 2 (or QoS flow 3) as the QoS flow to be transmitted first and LCH 1 has data with same MMSID but is not scheduled (e.g., due to Bj<0), the data of the MMSID will be multiplexed as soon as possible with relaxation of Bj.

In one embodiment, an RRC configuration may include synchronization information such as dependent LCH or synchronization threshold value. The synchronization information may be maintained for an LCH. The synchronization information may include a new multi-modal synchronization timer for counting down the time for an LCH. The timer may be started when the LCP handles data (e.g., data in a visual/audio LCH) belonging to the same synchronized burst in a tactile LCH. The RRC configuration may include a specific priority for a logical channel, wherein the specific priority may be configured for multi-modality synchronization. With regard to coexistence of delay-aware LCP, the specific priority of Multi-modal LCP may be the same with or different from the additional LCH priority of delay-aware LCP. If a collision occurs between the delay-aware LCP and the Multi-modal LCP, the lower value of the specific LCH priority can be used for LCP operation.

In one embodiment, the MAC entity shall, when a new transmission is performed: allocate resources to the logical channels as follows: if a logical channel has data with MMSID in the buffer, and a logical channel j with lower priority (i.e., larger priority value) has data with the same MMSID in the buffer, the MAC entity shall use the specific priority of the logical channel j during the subsequent duration, wherein the time value of the duration is equal to SYNCThreshold value.

In one embodiment, the MAC entity shall, when a new transmission is performed: allocate resources to the logical channels as follows: if a logical channel has data with MMSID in the buffer, and a logical channel j has data with the same MMSID in the buffer, and if the next UL transmission has been or can be scheduled within the subsequent duration (time value of the duration is equal to SYNCThreshold value), the logical channel j is allocated resources for the next UL transmission, and Bj of the logical channel j is updated to a specific value. The specific value may be determined as follows: update the value according to data volume with the same MMSID in the buffer of logical channel j; or value=max {the data volume with the same MMSID in the buffer of logical channel j, Bj+PBR×elapsed time to the next UL transmission}, where PBR represents prioritized bit rate.

In one embodiment, the MAC entity shall, when a new transmission is performed: allocate resources to the logical channels as follows: if a logical channel has data with MMSID in the buffer, and a logical channel j with higher priority (i.e., smaller priority value) has data with the same MMSID in the buffer, and if the next UL transmission has been or can be scheduled within the subsequent duration (time value of the duration is equal to SYNCThreshold value), the logical channel j is allocated resources for the next UL transmission, and Bj of the logical channel j is updated to a specific value. The specific value may be determined as follows: update the value according to data volume with the same MMSID in the buffer of logical channel j; or value=max {the data volume with the same MMSID in the buffer of logical channel j, Bj+PBR×elapsed time to the next UL transmission}.

If pdu-SetDiscard is not configured to the UE, and the remaining time of the PDCP SDU until discardTimer expiry is less than the remaining TimeThreshold, the PDCP SDU corresponding to the remaining time can be regarded as a delay-critical PDCP SDU. If pdu-SetDiscard is configured to the UE, and a PDCP SDU and a delay-critical PDCP SDU are in the same PDU set, the PDCP SDU can also be regarded as another delay-critical PDCP SDU. If parameter syncMM is configured to the UE, a PDCP SDU belongs to a burst composed with multiple sub-bursts from dependent QoS flows (i.e., QoS flows with the same MMSID), and at least one of the sub-bursts includes a delay-critical PDCP SDU, the PDCP SDU can also be regarded as another delay-critical PDCP SDU. In other words, if a MMSID of a PDCP SDU is the same as a MMSID of a delay-critical PDCP SDU, the PDCP SDU can be regarded as another delay-critical PDCP SDU. A UE may report the data volume of one or more delay-critical PDCP SDUs to the network via a delay status report (DSR).

The parameter syncMM may be configured for each PDCP entity independently or may be configured across multiple PDCP entities. If syncMM is configured, all data belonging to the same MMSID need to be synchronized. The data mentioned above may correspond to the same burst (or the same QoS flow or the same PDCP entity) or different bursts (or different dependent QoS flows or different PDCP entities). Therefore, when one or more PDCP SDUs become delay-critical, the remaining data belonging to the same MMSID in different QoS flows may also become delay-critical.

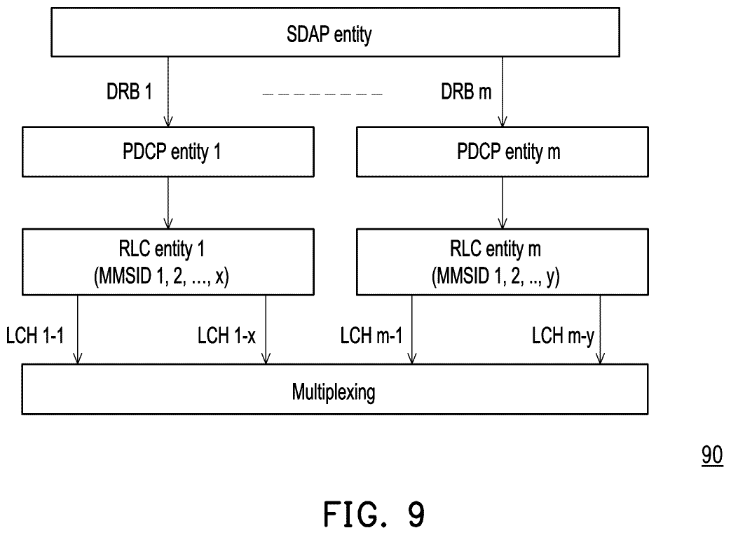

FIG. 9 illustrates a schematic diagram 90 of LCH buffer splitting based on MMSID according to one embodiment of the present disclosure. In a scenario where the ratio of the number of QoS flows and the number of DRBs is N:1 (N may be a positive integer greater than 1), multiples PDCP entities (e.g., m PDCP entities, where m is a positive integer) of a UE may receive different data flows (e.g., QoS flows) from the service data adaptation protocol (SDAP) entity of the UE. Each PDCP entity may deliver the data flow from the PDCP buffer to a corresponding RLC entity of the UE. A DRB can be split to more than one sub-logical channels. For example, DRB 1 may be split to x sub-logical channels with different MMSIDs (e.g., MMSID 1, 2, . . . , x, where x is a positive integer). DRB m may be split to y sub-logical channels with different MMSIDs (e.g., MMSID 1, 2, . . . , y, where y is a positive integer). The RLC entity of the UE may transmit data flows with different MMSID by using the same LCH. For example, the UE may respectively deliver multiple data flows to the MAC entity of the UE for multiplexing through multiple sub-LCHs of the same LCH (or DRB). In this case, logical channel identification (LCID) extension is not needed, and sub-LCH identification is only used at the UE side for LCP. For example, multiple data flows belonging to MMSID 1 may be deliver from multiple RLC buffers to the MAC entity respectively via multiple sub-LCHs (1-1) to (m-1), wherein sub-LCH (1-1) to sub-LCH (m-1) are configured with the same MMSID 1. Multiple data flows corresponding to the same MMSID may be stored in the same MAC buffer of the UE.

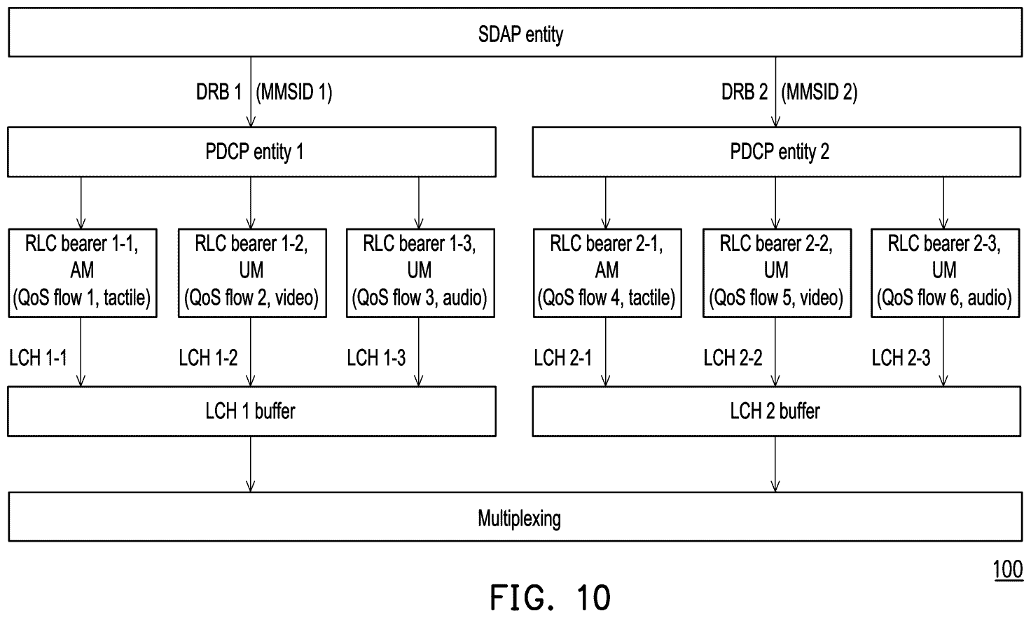

FIG. 10 illustrates a schematic diagram 100 of RLC bearer splitting based on QoS requirements according to one embodiment of the present disclosure. The SDAP entity of the UE may deliver multiple data flows with different MMSIDs from the SDAP buffer to multiple PDCP entities respectively. For example, the data flow corresponding to MMSID 1 may be delivered from the SDAP buffer to the PDCP buffer of PDCP entity 1 via DRB 1, and the data flow corresponding to MMSID 2 may be delivered from the SDAP buffer to the PDCP buffer of PDCP entity 2 via DRB 2. A DRB can be split to more than one RLC channels. That is, multiple data flows corresponding to the same MMSID may be stored in the same PDCP buffer of the UE. Each PDCP entity (e.g., PDCP entity 1 or PDCP entity 2) may transmit the multiple data flows to a corresponding MAC buffer respectively through multiple RLC bearers based on the QoS requirements of each data flows, wherein the multiple data flows (or multiple sub-logical channels corresponding to the multiple data flows) may belong to the same LCH or DRB.

For example, assume that PDCP entity 1 stores QoS flow 1, QoS flow 2, and QoS flow 3 corresponding to the same MMSID (i.e., MMSID 1) in the PDCP buffer. Since QoS flow 1, QoS flow 2, and QoS flow 3 correspond to tactile data, video data, and audio data, PDCP entity 1 may determine that QoS flow 1, QoS flow 2, and QoS flow 3 are corresponded to different QoS requirements. Accordingly, PDCP entity may transmit QoS flow 1 to LCH 1 buffer through RLC bearer 1-1 and LCH 1-1 by using acknowledged mode (AM), transmit QoS flow 2 to LCH 1 buffer through RLC bearer 1-2 and LCH 1-2 by using unacknowledged mode (UM), and transmit QoS flow 3 to LCH 1 buffer through RLC bearer 1-3 and LCH 1-3 by using UM. LCH 1-1, LCH 1-2, and LCH 1-3 may belong to the same LCH (i.e., LCH 1) or DRB.

For example, assume that PDCP entity 2 stores QoS flow 4, QoS flow 5, and QoS flow 6 corresponding to the same MMSID (i.e., MMSID 2) in the PDCP buffer. Since QoS flow 4, QoS flow 5, and QoS flow 6 correspond to tactile data, video data, and audio data, PDCP entity 2 may determine that QoS flow 4, QoS flow 5, and QoS flow 6 are corresponded to different QoS requirements. Accordingly, PDCP entity may transmit QoS flow 4 to LCH 2 buffer through RLC bearer 2-1 and LCH 2-1 by using AM, transmit QoS flow 5 to LCH 2 buffer through RLC bearer 2-2 and LCH 2-2 by using UM, and transmit QoS flow 6 to LCH 2 buffer through RLC bearer 2-3 and LCH 2-3 by using UM. LCH 2-1, LCH 2-2, and LCH 2-3 may belong to the same LCH (i.e., LCH 2) or DRB.

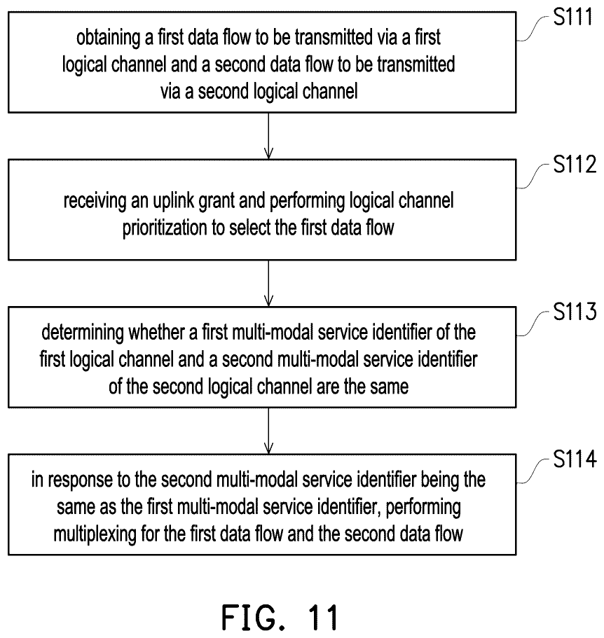

FIG. 11 illustrates a flowchart of a method of multi-modal synchronization according to one embodiment of the present disclosure, wherein the method can be implemented by a transmitting end (e.g., a MAC entity of a UE). In step S111, obtaining a first data flow to be transmitted via a first logical channel and a second data flow to be transmitted via a second logical channel. In step S112, receiving an uplink grant and performing logical channel prioritization to select the first data flow. In step S113, determining whether a first multi-modal service identifier of the first logical channel and a second multi-modal service identifier of the second logical channel are the same. In step S114, in response to the second multi-modal service identifier being the same as the first multi-modal service identifier, performing multiplexing for the first data flow and the second data flow.

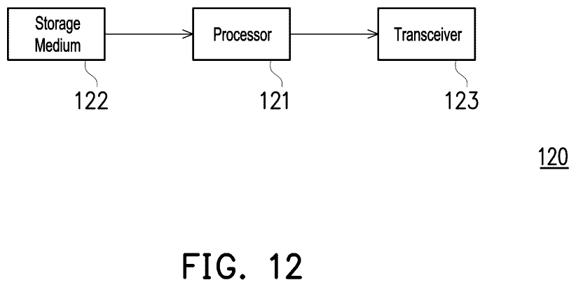

FIG. 12 illustrates a schematic diagram of a communication device 120 according to one embodiment of the present disclosure. The communication device 120 may include a processor 121, a storage medium 122, and a transceiver 123. The processor 121 is coupled to the storage medium 122 and the transceiver 123 and is configured to at least to implement the method as described in FIGS. 1-11 as well as its exemplary embodiment and alternative variations. In one embodiment, the communication device 120 may be implemented as the UE or the BS (e.g., network or network node) as mentioned above.

The processor 121 coupled be implemented by using programmable units such as a micro-processor, a micro-controller, a digital signal processor (DSP), a field programmable gate array (FPGA), etc. The functions of the processor 121 may also be implemented with separate electronic devices or ICs. It should be noted that functions of the processor 121 may be implemented with either hardware or software.

The storage medium 122 may be, for example, any type of fixed or removable random access memory (RAM), a read-only memory (ROM), a flash memory, a hard disc drive (HDD), a solid state drive (SSD) or similar element, or a combination thereof, configured to record a plurality of modules or various applications executable by the processor 121. The storage medium 122 may store a buffer (e.g., MAC buffer, RLC buffer, PDCP buffer, or SDAP buffer) or an entity (e.g., MAC entity, RLC entity, PDCP entity, or SDAP entity).

The transceiver 123 may be configured to transmit and receive signals respectively in the radio frequency. The transceiver 123 may also perform operations such as low noise amplifying, impedance matching, frequency mixing, up or down frequency conversion, filtering, amplifying, and so forth. The transceiver 123 may include one or more digital-to-analog (D/A) converters or analog-to-digital (A/D) converters which are configured to convert from an analog signal format to a digital signal format during uplink signal processor and from a digital signal format to an analog signal formant during downlink signal processing. The transceiver 123 may include an antenna array which may include one or more antennas to transmit and receive omni-directional antenna beams or directional antenna beams.

Based on the above, the disclosed UE may perform LCP to select an SDU based on the transmission priority. After the SDU is selected, the UE may adjust the priority of another SDU corresponding to the same MMSID so as to ensure the synchronization between SDUs corresponding to the same service. The priority of the SDU can be adjusted by the UE in a specific time period. After the time period, the priority of the SDU can be restored to the original value, as the data burst of the service can no longer be synchronized. If the transmission of the SDU is restricted by a budget variable, the budget variable may be relaxed by the UE, and the SDU can be transmitted as soon as possible.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method of multi-modal synchronization, suitable for a user equipment, comprising:
obtaining a first data flow to be transmitted via a first logical channel and a second data flow to be transmitted via a second logical channel;
receiving an uplink grant and performing logical channel prioritization to select the first data flow;
determining whether a first multi-modal service identifier of the first logical channel and a second multi-modal service identifier of the second logical channel are the same; and
in response to the second multi-modal service identifier being the same as the first multi-modal service identifier, performing multiplexing for the first data flow and the second data flow.

2. The method according to claim 1, further comprising:
storing a plurality of data flows in a buffer, wherein the plurality of data flows comprise the first data flow and the second data flow; and
delivering the plurality of data flows from the buffer to a network.

3. The method according to claim 2, wherein the buffer is a medium access control buffer of the user equipment.

4. The method according to claim 2, wherein the buffer is a packet data convergence protocol buffer of the user equipment.

5. The method according to claim 2, wherein the plurality of data flows further comprise a third data flow to be transmitted via a third logical channel, wherein a third multi-modal service identifier corresponding to the third logical channel is different from the first multi-modal service identifier, wherein the first data flow and the third data flow belong to the same data radio bearer.

6. The method according to claim 2, wherein the plurality of data flows further comprise a fourth data flow to be transmitted via a fourth logical channel, wherein a fourth multi-modal service identifier corresponding to the fourth logical channel is the same as the first multi-modal service identifier, wherein the first data flow and the fourth data flow belong to the same data radio bearer.

7. The method according to claim 6, wherein the first data flow and the fourth data flow belong to different Radio Link Control entities.

8. The method according to claim 1, wherein the step of performing the multiplexing for the first data flow and the second data flow comprises:
receiving a configuration message and obtaining an allowed list from the configuration message;
determining whether a multi-modal service identifier associated with the uplink grant matches the allowed list of the first multi-modal service identifier of the first logical channel; and
in response to the multi-modal service identifier associated with the uplink grant matching the allowed list of the first logical channel, performing the multiplexing for the first data flow.

9. The method according to claim 1, wherein the step of performing the multiplexing for the first data flow and the second data flow comprises: in response to the second multi-modal service identifier being the same as the first multi-modal service identifier, applying an additional priority of the second data flow; and
performing the multiplexing for the second data flow according to the additional priority.

10. The method according to claim 9, wherein the additional priority is applied to the second logical channel and is configured from the configuration message.

11. The method according to claim 9, wherein the additional priority is applied during a time period after the first data flow has been selected.

12. The method according to claim 1, further comprising:
decreasing a budget variable after delivering data from a buffer via the second logical channel;
in response to the budget variable dropping below a threshold and the second multi-modal service identifier being different from the first multi-modal service identifier, stopping delivering the second data flow from the buffer; and
in response to the budget variable dropping below the threshold and the second multi-modal service identifier being the same as the first multi-modal service identifier, delivering the second data flow from the buffer.

13. The method according to claim 12, wherein the step of delivering the second data flow from the buffer comprises:
delivering the second data flow during a time period after the first data flow has been selected.

14. The method according to claim 1, further comprising:
determining the first data flow as a first delay-critical data flow;
in response to the second multi-modal service identifier being the same as the first multi-modal service identifier, determining the second data flow as a second delay-critical data flow; and
reporting the first delay-critical data flow and the second delay-critical data flow via a delay status report.

15. The method according to claim 14, wherein the first logical channel and the second logical channel correspond to the same packet data convergence protocol entity of the user equipment.

16. The method according to claim 14, wherein the first logical channel and the second logical channel respectively correspond to different packet data convergence protocol entities of the user equipment.

17. A user equipment, comprising:
a transceiver; and
a processor, coupled to the transceiver and configured to:
obtain a first data flow to be transmitted via a first logical channel and a second data flow to be transmitted via a second logical channel;
receive an uplink grant and performing logical channel prioritization to select the first data flow;
determine whether a first multi-modal service identifier of the first logical channel and a second multi-modal service identifier of the second logical channel are the same; and
in response to the second multi-modal service identifier being the same as the first multi-modal service identifier, perform multiplexing for the first data flow and the second data flow.
